(19) United States
(12) Patent Application Publication
(10) Pub. No.: US 2006/0240343 A1
(43) Pub. Date: Oct. 26, 2006

(54) Digital press printing

(75) Inventors: Richard David Saunders, Windsor Berkshire (GB); Peter Sinclair, Amersham (GB)

Correspondence Address: KNOBBE MARTENS OLSON & BEAR LLP, 2040 MAIN STREET, FOURTEENTH FLOOR, IRVINE, CA, 92614, US

(73) Assignee: ARJO WIGGINS FINE PAPERS LIMITED, Chineham Basingstoke (GB)

(21) Appl. No.: 10/539,687

(22) PCT Filed: Dec. 17, 2003
(86) PCT No.: PCT/GB03/05514

§ 371 Date: Jul. 14, 2005

(30) Foreign Application Priority Data
Dec. 20, 2002 (GB) 0229711.7

(51) Int. Cl. G03G 9/12; G03G 15/10

(52) U.S. Cl. 430/10; 430/112; 430/114; 430/97; 430/117

(57) ABSTRACT

A liquid toner digital press imaging composition contains, in addition to the toner, a security ingredient which is a reactant reactable in use with a complementary reactant carried by a printable substrate, so as to be detectably retained in or on the substrate in the event of fraudulent alteration or removal of the image produced by the toner.

This invention relates to digital press printing using liquid toner compositions, often referred to as “inks” or “electro-inks”. Liquid toner digital presses have been extensively commercialized by Indigo N.V., now Hewlett-Packard, Indigo and these presses are widely referred to simply as “Indigo”* presses.

Digital presses are particularly suited to short printing runs for which traditional printing, particularly colour offset printing, can be uneconomic and slow because of the high cost and time penalties involved in producing printing plates and setting up the press at the start of the run. By contrast, a digital press has no printing plates or comparable set-up costs. It therefore permits a rapid response to print orders (“fast turnaround”), and the cost per impression is not significantly influenced by the total number of impressions being made. These factors make a digital press ideal for short-run printing, typically up to about 800 impressions, but sometimes up to about 3000 impressions. Since the information to be printed is stored in electronic form (“digitised”), rather than physically on a printing plate, initial and repeat print-runs can be made “on demand” without the need for physical changes to the press. A further benefit is that variable and non-variable information can be merged between every consecutively printed copy, so that individual impressions within a print run can be personalised or customised so as to be specific to a particular recipient or reader.

Most digital press technology is based on non-impact printing or imaging technology of the same general kind as used in plain paper photocopiers and laser printers, i.e. on the use of an electrostatically-charged roll and charged toner particles for image formation. An electrostatically-charged photosensitive roll (the “photoreceptor”) is exposed to light in an imagewise configuration such that the surface electrostatic charge on the exposed areas of the photoreceptor is dissipated. Toner is then brought into contact with the photoreceptor, and adheres strongly to it in the unexposed (and thus still electrostatically-charged) areas of its surface, from which it can be transferred to the paper either directly or indirectly via an offset roll.

A single pass through the printing unit provides a monochrome image, but a colour print of a quality comparable to that obtainable by traditional colour offset printing can be achieved either by multiple passes through a printing unit using differently-coloured toners or by a single pass through an array of printing units each of which applies a differently-coloured toner. Typically four passes or printing units are used, three of which apply coloured toners and the other of which applies a black toner. The coloured toners are such that when used individually and in suitable combinations, they can provide a complete spectral range for the finished print, in much the same way as is achieved in conventional colour printing by the use of a black and three differently-coloured inks.

Currently-commercialised digital presses can be divided into two groups according to the type of toner used, i.e. whether it is a “dry toner” or a “liquid toner”. Dry toners are of a fine particulate nature, with each particle comprising pigment particles bound together in a thermally-fusible polymeric binder matrix. Once the toner has been applied to the paper, heat is used to melt the polymeric binder component of the toner and so “fuse” the toner particles together and to the paper. By contrast, liquid toner compositions comprise very fine toner particles dispersed in a fairly high-boiling organic liquid vehicle, together with dispersed binder particles. During the printing operation, most of the vehicle is thought to be removed and the toner is heated to an elevated temperature (typically 70-90° C.) sufficient to convert the binder particles to a liquid state. Removal of the vehicle results in an increase in toner viscosity, which facilitates transfer of the toner to the offset roll (if used) and to the paper, with the paper surface absorbing the residual liquid vehicle. The binder reverts to a solid state after the toner has been applied to the paper and so fixes the image (there is no subsequent “fusing” of the toner after its transfer to the paper, such as occurs in dry toner processes).

A problem sometimes encountered with liquid toner digital press printing is that the toner does not bond firmly to the paper. As a result, it can become dislodged, so that the print lacks permanence. This problem can be overcome for most applications by suitable choice of paper. For example pigment-coated printing papers generally give good results, whereas uncoated papers may not, unless they are specially treated (as disclosed for example in European Patent Application No. 879917A or International (PCT) Patent Applications Nos. WO 96/06384A or WO 00/44568A). However, even with such papers, there is a risk that toner-printed characters can be removed from a printed document using a scalpel or other means and then replaced by other characters. As a result, liquid toner digital press printing has not been widely used for security printing purposes for which it would otherwise be well suited, particularly the printing of security documents containing variable or personal information such as a monetary amount, or the name or photograph of a payee, account holder, document owner or card owner. It will be understood that the expression “security documents” in this context includes not just complete documents but also inserts to be incorporated in such documents or in plastic cards with a security function, for example credit or charge cards, membership or identity cards, etc.

Although there may still be scope to improve the strength of the bond between paper and liquid toner inks, we have conceived an alternative approach to the prevention of attempts at fraudulent alteration of security documents or the like which have been printed using liquid toner digital presses. This approach is based on an appreciation of the possibilities offered by the liquid nature of the toner composition, and more particularly that the liquid vehicle in the composition can be used not just for toner and binder, as at present, but also for a novel security ingredient. More specifically, we propose to include a security ingredient in the toner composition which interacts with a complementary paper or other printable substrate to produce a visual or other recognizable effect which will remain even if the toner itself is interfered with or removed, thereby making attempts at fraudulent alteration evident and consequently ineffective.

Accordingly, the present invention provides, in a first aspect, a liquid toner digital press imaging composition, characterized in that the composition contains, in addition to the toner, a security ingredient which is a reactant reactable in use with a complementary reactant carried by a printable substrate so as to be detectably retained in or on the substrate in the event of fraudulent alteration or removal of the image produced by the toner.

In a second aspect, the present invention provides a liquid toner digital press imaging system comprising a liquid toner digital press imaging composition and a printable substrate, characterized in that the imaging composition contains, in addition to the toner, a security ingredient which is a reactant reactable in use with a complementary reactant carried by the printable substrate so as to be detectably retained in or on the substrate in the event of fraudulent alteration or removal of the image produced by the toner.

The security ingredient may include one or more components, for example it may include:

(i) a reactant reactable in use with a complementary reactant carried by the printable substrate so as to generate a coloured, fluorescent or chemically-detectable image on the substrate having the same configuration as the toner-printed image (by a “chemically-detectable” image is meant an image which can be revealed by application of a complementary reagent which reacts with the security ingredient to produce colour or a colour change);

(ii) a visible dye which is absorbed and/or wicked away by the substrate so as to produce a “halo” effect around the periphery of the toner image and/or an image on the opposite surface of the substrate as a result of “strike through”, i.e. penetration, to the opposite surface of the substrate; or

(iii) a fluorescent material which acts in a similar way to the visible dye just mentioned but which is invisible under normal lighting conditions but visible when illuminated with UV light.

The fluorescent systems referred to above provide covert security, in that the presence of the security feature is not immediately apparent, in contrast to overt, i.e. visible, systems as in (ii) above or the colour image generation variant in (i) above.

The arrangement described in (i) above is currently preferred, in that the requirement for a reaction between a component in the toner imaging composition and a component carried by the substrate makes forgery or counterfeiting especially difficult and also serves as a means of verifying that both the imaging composition and the substrate are genuine. The last-mentioned feature is particularly useful, in that digital printing technology can lend itself to counterfeiting as well as genuine production (dishonest press owners equipped with a scanner could fairly readily capture a design format from an original and then input their own images and personalised printing to produce a multiplicity of individual fakes).

Systems (i) to (iii) described above all have the advantage that authentication or verification is very simple, relying on visual examination or simple equipment such as a UV lamp or a pen or other applicator to apply a complementary reagent. In principle however, systems relying on more complex means of verification could be used, for example electronic sensors for detection of magnetic or conductive materials, or spectroscopic analysis to test for the presence of specific chemicals.

If desired, more than one security ingredient can be present in the imaging composition, to provide added security. In such a case, the security ingredients used can fall into one or more of the categories described in (i) to (iii) above.

Apart from the presence of the security ingredient, the imaging composition can be conventional in nature. Typically it comprises a fine particulate toner dispersed in a liquid vehicle together with a binder.

The printable substrate is normally a natural or synthetic paper, but in principle could be any other material having a printable surface (a “synthetic paper” is a plastics sheet material manufactured so as to simulate the printability, stiffness, handling and other characteristics of natural cellulosic paper, for example a product as sold under the trade mark “Polyart” by Arjobex Limited, Clacton-on-Sea, England). A natural paper offers a wider range of authentication or verification possibilities, since it is absorbent and therefore can permit strike-through and/or wicking to produce a halo effect.

In a preferred embodiment of the invention, the colour generating reactant in the imaging composition is a colourless chromogenic material (often termed a “colour former”) of the kind used for image generation in pressure-sensitive copying papers (often termed “carbonless” copying papers) and the complementary reactant in the printable substrate is a colour developer of the kind used in such papers. In principle however, any colour generating combination of reactants can be used in the present invention, provided the reactant for inclusion in the toner is soluble or otherwise capable of reacting in the liquid vehicle used in the toner composition to an extent sufficient to facilitate a colour generating reaction in use, i.e. when the toner composition contacts the complementary reactant carried by the substrate.

Chromogenic materials and colour developers as just referred to are very well known and are extensively disclosed in detail in the patent and other literature relating to pressure-sensitive copying papers. A paper presented by Dr. J. C. Petitpierre at the 1983 Tappi Coating Conference and entitled “Dyes and Chemicals for Carbonless Copying Paper: History, Present Situation, Problems and Trends” provides a useful introductory source of reference for this technology.

Preferred colour formers for inclusion in the liquid toner imaging composition include: phthalides such as 3,3-bis(1-n-octyl-2-methylindol-3-yl)phthalide as disclosed in British Patent No. 1389716 and commercially available as “Pergascript”* Red I-6B from Ciba Speciality Chemicals and 3,3-bis(4-dimethylaminophenyl)-6-dimethylaminophthalide, more commonly knows as Crystal Violet Lactone or CVL, and commercially available under the names “Pergascript”* Blue I-R from Ciba Speciality Chemicals, “Copikem”* 1 from BF Goodrich and as “CVL” from Yamada Chemical Co. Ltd., Kyoto, Japan; and fluorans such as 3-diethylamino-6-methyl-7-(2′,4′-dimethylanilino)fluoran as disclosed in British Patent No. 1339968 and commercially available under the name “Black XV” from Yamamoto Chemicals Inc., Osaka, Japan, and 3-diethylamino-7-dibenzylaminofluoran, commercially available as “Pergascript”* Green I-2GN from Ciba Speciality Chemicals, “Green 300” from Yamada Chemical Co. Ltd., “Copikem”*5 from BF Goodrich and “Green 8-C” from Hodogaya Chemical Co. Ltd., Tokyo, Japan, or mixtures thereof.

Preferred colour developers for use in the printable substrate include: acid-washed montmorillonite clays such as disclosed in British Patent No. 1213835 and commercially available under the names “Fulacolor”* from Rockwood Additives Ltd., Widnes, U.K., “Silton”* from Mizusawa Industrial Chemicals Ltd., Tokyo, Japan and “Copisil”* from Süd Chemie A.G., Moosburg, Germany; phenolic resins, such as described in U.S. Pat. No. 3,672,935 or No. 4,612,254; organic acids or metal salts thereof, e.g. as described in U.S. Pat. No. 3,024,927, European Patent Application Nos. 275107A, 503443A or 521474A, or German Offenlegungsschrift No. 4110354A; or salicylated phenolic resins such as those disclosed in European Patent Application No. 194601A and supplied under the trade mark “Durez” by Durez Corporation, Dallas, USA and N.V. Durez Europe S.A., Genk, Belgium or as disclosed in European Patent Application No. 338 808A and supplied by Schenectady Chemicals, Schenectady USA, or mixtures thereof.

To prepare the printable substrate, the colour developer material is first formulated into a coating composition with a suitable binder, for example a styrene-butadiene or other latex and, optionally, other materials such as pigments to improve printability, fillers, viscosity modifiers and additives of various kinds. The coating composition is then coated on to the substrate using blade, rod, air-knife, metering roll, metered size press, or other conventional coating methods.

Conveniently, the coating composition is formulated in a similar manner to conventional colour developer compositions as used in pressure-sensitive copying paper, and the printable substrate can of course actually be a colour developer sheet as manufactured for use as a CF or “Coated Front” sheet in pressure-sensitive copying systems. This may offer economic advantages, since such products are well-established and widely available.

The organic colour developer materials referred to above are oil-soluble, and so if desired they may be used in a reverse arrangement to that just described, i.e. as the colour generating reactant in the liquid toner composition, with solid colour former material present in the printable substrate as the complementary reactant.

Although the reactant in the printable substrate is typically present in the form of a surface coating, it may alternatively be present as a loading or impregnant within the body of the substrate, particularly when the substrate is of paper. Preferably, the colour developer is incorporated inside the substrate.

The paper or other substrate used in the present invention may contain sensitisers or other conventional security chemicals as commonly used in security papers to provide an additional safeguard against attempts at fraudulent alteration using, for example, bleaches, solvents, proprietary ink removers and such like. Such security chemicals must of course be compatible with the security ingredient used.

The invention will now be illustrated by the following Examples, in which all parts and percentages are by weight unless otherwise stated.

### EXAMPLE 1

0.1% and 1% solutions of a red-developing colour former (“Pergascript”* Red I-6B) were made up in an isoparaffinic solvent (“Isopar L*” supplied by Exxon Chemical). 8 parts of fine particulate toner formulated in a paste of a kind conventionally used for liquid toner digital press printing and sold as “Electrolnk”* by Hewlett Packard, Indigo were then dispersed in 100 parts of each of the colour former solutions to produce a liquid toner “ink”. The resulting inks were then separately applied to respective 49 g m⁻² carbonless CF sheets (“Idem”* CF, supplied by Arjo Wiggins Limited, Basingstoke, United Kingdom) using a laboratory gravure coating plate to simulate the action of a digital press. After the ink had dried, the toner could be removed from the papers by scraping with a finger nail. A red residual developed image remained in each case and revealed that the originally-applied toner image had been tampered with and removed.

### EXAMPLE 2

A 1% concentration of a red colourformer, I-6B, was made in imaging oil (an oil solvent) by gentle heating of the oil, with stirring, to 50° C. This colourformer imaging oil was then added to the black ink tank and oil separator tank of a HP/Indigo* 1000 digital printing press. A black text image was then printed onto carbonless CF paper. The printed image was then removed using masking tape and a dark pink colourformer image was found to be clearly visible underneath the removed printed image and also in transmitted light through the opposite surface of the substrate.

A lighter pink background colouration of the non-image areas of the carbonless CF paper was also observed. It is believed that this background colouration was caused by inadequate removal of imaging oil from the non-image-forming areas of the printing plate. The background colouration was significantly reduced subsequently by adding clean imaging oil to the separator, to reduce the concentration of colourformer in the oil. If required, it should be possible to reduce the background colouration to an insignificant level by optimizing the colourformer and reactive pigment concentrations. The background colouration may however be useful as a secondary security feature, providing a method of authenticating the paper.

Various modifications of the invention described above are of course possible. For example, although the red colourformer I-6B was selected for the above examples owing to its high solubility, other colourformers or colourformer blends may be used to give different coloured images. Also, although in the above examples CF was used as the co-reacting paper, owing to its availability and strong colour reaction properties, it could be possible for the coating containing the carbonless type image to be removed by a forger. It may therefore be preferable to make the paper by adding the co-reacting pigments at the wet end of the process so that they are carried within the body of the paper. The final carbonless image will then penetrate through the sheet, making it much more difficult to remove.
* In this specification, an asterisk indicates a proprietary trade mark.

1. A liquid toner digital press imaging composition, characterized in that the composition comprises, in addition to the toner, a security ingredient which is a reactant reactable in use with a complementary reactant carried by a printable substrate so as to be detectably retained in or on the substrate in the event of fraudulent alteration or removal of an image produced by the toner.

2. A liquid toner digital press imaging composition as claimed in claim 1, wherein the security ingredient is a reactant reactable in use with a complementary reactant carried by the printable substrate so as to generate a colored, fluorescent or chemically-detectable image in or on the substrate having the same configuration as the toner-printed image

3. A liquid toner digital press imaging composition as claimed in claim 1, wherein the said security ingredient is colorless.

4. A liquid toner digital press imaging composition as claimed in claim 1, wherein the said security ingredient is absorbed and/or wicked away by the substrate so as to produce a “halo” effect around the periphery of the toner image and/or an image on the opposite surface of the substrate.

5. A liquid toner digital press imaging composition as claimed in claim 3, wherein the said security ingredient is a colorless chromogenic material of the kind used for image generation in pressure-sensitive copying papers.

6. A liquid toner digital press imaging composition as claimed in claim 5, wherein the said colorless chromogenic material is selected from 3,3-bis(1-n-octyl-2-methylindol-3-yl)phthalide or 3,3-bis(4-dimethylaminophenyl)-6-dimethylaminophthalide, or from 3-diethylamino-6-methyl-7-(2′,4′-dimethylanilino)fluoran or 3-diethylamino-7-dibenzylaminofluoran, or mixtures thereof.

7. A liquid toner digital press imaging composition as claimed in claim 1, wherein the security ingredient is a magnetic or conductive material.

8. A liquid toner digital press imaging composition as claimed in 1, wherein more than one security ingredient is present.

9. A liquid toner digital press imaging system comprising a liquid toner digital press imaging composition and a printable substrate, characterized in that the imaging composition comprises, in addition to the toner, a security ingredient which is a reactant reactable in use with a complementary reactant carried by the printable substrate so as to be detectably retained in or on the substrate in the event of fraudulent alteration or removal of an image produced by the toner.

10. A liquid toner digital press imaging system comprising a liquid toner digital press imaging composition and a printable substrate, characterized in that the imaging composition contains, in addition to the toner, a security ingredient which is a reactant reactable in use with a complementary reactant carried by a printable substrate so as to be detectably retained in or on the substrate in the event of fraudulent alteration or removal of an image produced by the toner is as claimed in either of claims 2 or 7.

11. A liquid toner digital press imaging system as claimed in claim 10, wherein when the security ingredient is a colorless chromogenic material of the kind used for image generation in pressure-sensitive copying papers, the printable substrate carries a color developer of the kind used in such papers for developing the color of the chromogenic material.

12. A liquid toner digital press imaging system as claimed in claim 11, wherein the color developer is incorporated inside the substrate.

13. A liquid toner digital press imaging system as claimed in claim 12, wherein the color developer is selected from acid-washed montmorillonite clays; or phenolic resins, or organic acids or metal salts thereof, or salicylated phenolic resins, or mixtures thereof.

14. A liquid toner digital press imaging system as claimed in claim 9, wherein the printable substrate carries sensitizers or other conventional security chemicals.

15. A liquid toner digital press imaging system as claimed in claim 9, wherein the substrate is a natural paper or a synthetic paper.

16. An anticounterfeiting method against fraudulent alteration or removal of the image produced by the toner on a substrate, comprising applying an imaging composition to a printable substrate, wherein the imaging composition comprises toner and a security ingredient which is a reactant reactable with a complementary reactant to produce a detectable reaction product retained on the substrate in the event of fraudulent alteration or removal of an image produced by the toner.
